(19) United States
(12) Patent Application Publication
(10) Pub. No.: US 2015/0084235 A1
(43) Pub. Date: Mar. 26, 2015

(54) Overmolding buckles at the same time as overmolding a lens respirator

(71) Applicant: Eric P. Rose, Tarzana, CA (US)

(72) Inventor: Eric P. Rose, Tarzana, CA (US)

(73) Assignee: MOLDEX-METRIC, INC., Culver City, CA (US)

(21) Appl. No.: 13/998,063

(22) Filed: Sep. 26, 2013

(51) Int. Cl. B29C 45/14

(52) U.S. Cl. CPC B29C 45/14377
USPC 264/279

(57) ABSTRACT

A respirator mask and a method of making the respirator mask that includes a lens member and a plurality of buckle members spaced around the lens member. A flange member is overmolded to the lens member and to the spaced buckle members at the same time by the following method. A mold member is provided to have individual mold supports to individually receive and support the lens member and to individually receive and support the buckle members at the spaced positions around the lens member. The mold member forms a flange cavity around the lens member and extending to the buckle members. The lens member is positioned within its individual mold support and the buckle members are positioned within their individual mold supports at the spaced positions around the lens member. The molding material is then injected into the flange cavity to form a flange that overmolds to the lens member while at the same time overmolds to the buckle members to form the respirator mask.

This Divisional Application is based on U.S. application Ser. No. 12/925,446 filed on Oct. 21, 2010 which in turn is based on U.S. Provisional Application #61/280,063 filed on Oct. 29, 2009 by Eric P. Rose for Overmolding Buckles At The Same Time As Overmolding Lens Respirator.

### BACKGROUND OF THE INVENTION

This invention is in the field of respirators used for personal protection. Respirators require an attachment means which allow the respirator to be affixed securely to the user's face. In most reusable respirators, this attachment means is accomplished through the use of a plurality of buckles which connect the mask body to a harness. These buckles typically have an adjustments means which allows a user to adjust the fit of the mask body to the face as needed depending on the size and shape of their face. Respirator manufactures have used several techniques of inserting buckles into a respirator. Most often this is achieved by means of a rivet that extends through a tab on a mask's flange and simultaneously through a buckle. Secondarily, a separate harness may be strung through the buckle allowing for an adjustment means of securing the mask to the face. This joint assembly of flange tab, rivet, buckle, and harness may be repeated a plurality of times on the mask as desired by the manufacturer.

The common method of attaching a mask body to a harness through the system of rivet and buckle as noted above has numerous shortcomings. Market research has shown, and one skilled in the art would understand that, over time and with repeated use the rivet joint will loosen up and is likely to come apart. During use of the respirator, typically in hazardous environments, such loosening or unintended disassembly could possibly be hazardous to the user's health. From a load distribution perspective in this joint, the typically small rivets and the corresponding hole they require in the flange's tab offer relatively little surface area to carry the load in the joint. With such a traditional multipart assembly, significant costs would be incurred to produce and assemble the individual parts. This manufacturing cost results in a higher cost of the respirator to the user which may limit the availability of the product. Also with such a multipart assembly, the product is big, bulky and obtrusive and less aesthetically appealing.

### SUMMARY OF INVENTION

The invention described herein is novel for several reasons and is a significant improvement over prior art. This invention is one where the buckles used to attach the mask body to the harness are integrally molded to the flange's tabs at the same time as the flange itself is molded to the respirator's lens. The molding of the flange to the lens is part of a prior patent application Ser. No. 12/284,133 filed Sep. 18, 2008 and is assigned to the same assignee as the instant application. The flange would generally be injection molded and the molding material may be thermoplastic rubber but other materials such as silicone or even compression-molded rubber, or the like could be used.

This invention is novel and an improvement over prior art and the prior application referenced above for several reasons. First, because there is no rivet in the assembly there is no chance of such a joint loosening over time and extended use. Second, the invention uses a broad surface area between the flange tabs and the buckle portions so as to insure a firm connection. The buckle portions may also include openings extending through the buckle portions so that the molding of the flange tabs also may be through the openings to further secure the connection between the flange tabs and the buckle portions.

The present invention is simpler in construction, simpler in manufacturing and lower in cost due to fewer parts and less hand assembly than the prior art devices.

A clearer understanding of the invention will be had with reference to the following description and drawings.

### BRIEF DESCRIPTION OF THE DRAWINGS

FIG. 1 illustrates the component parts of the respirator to be assembled during the molding of the flange,

FIG. 2 illustrates the component parts of the respirator assembled by the molding of the flange,

FIG. 3 illustrates the component parts of the respirator positioned in a two-piece mold, and

FIG. 4 illustrates the assembled parts of the respiration positioned in the mold after molding the flange.

### DETAILED DESCRIPTION OF THE DRAWINGS

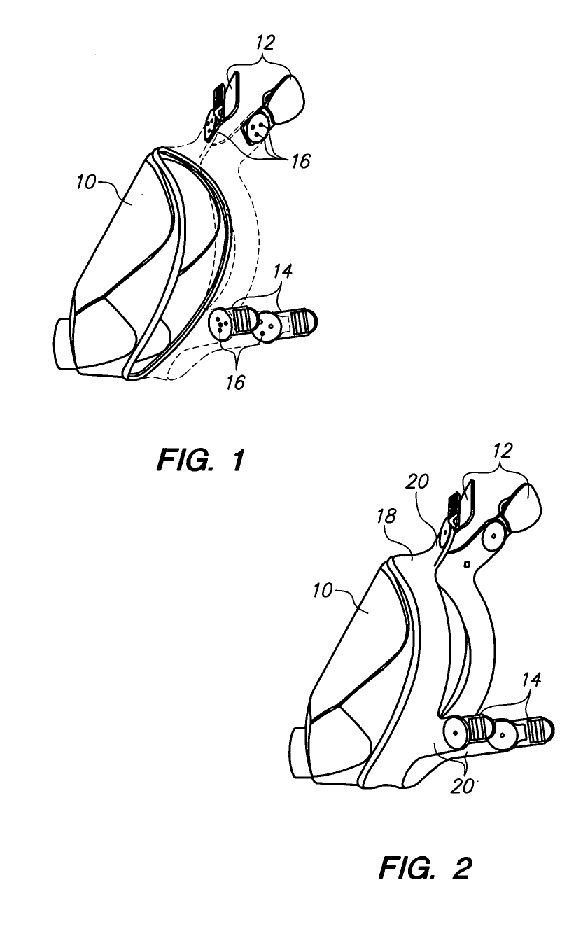

As illustrated in FIG. 1, the component parts of the respirator include a lens 10, two upper buckle portions 12 and two lower buckle portions 14. As can be seen in FIG. 1 both upper and lower portions 12 and 14 include openings there through 16 which assists during the molding of a flange member interconnecting the lens 10 and the buckle portions 12 and 14.

FIG. 2 illustrates a completed respirator after molding flange. Specifically as shown in FIG. 2 a flange member 18 is overmolded to the lens 10 and the buckle portions 12 and 14. The overmolding of the flange to the lens 10 is fully described in the previously referenced patent application assigned to the same Assignee as the instant application. The overmolding of the flange is accomplished with tab portions 20 extending from the flange 12 and with these tab portions encapsulating the upper and lower flange members in the area of these flange members that include the openings 16. The mold material will flow through the openings to lock the buckle portions in position. In addition, the tab portions 20 overlay part of the upper and lower buckle portions over a broad area to also ensure a secure engagement between the tab portions 20 and the buckle portions 12 and 14.

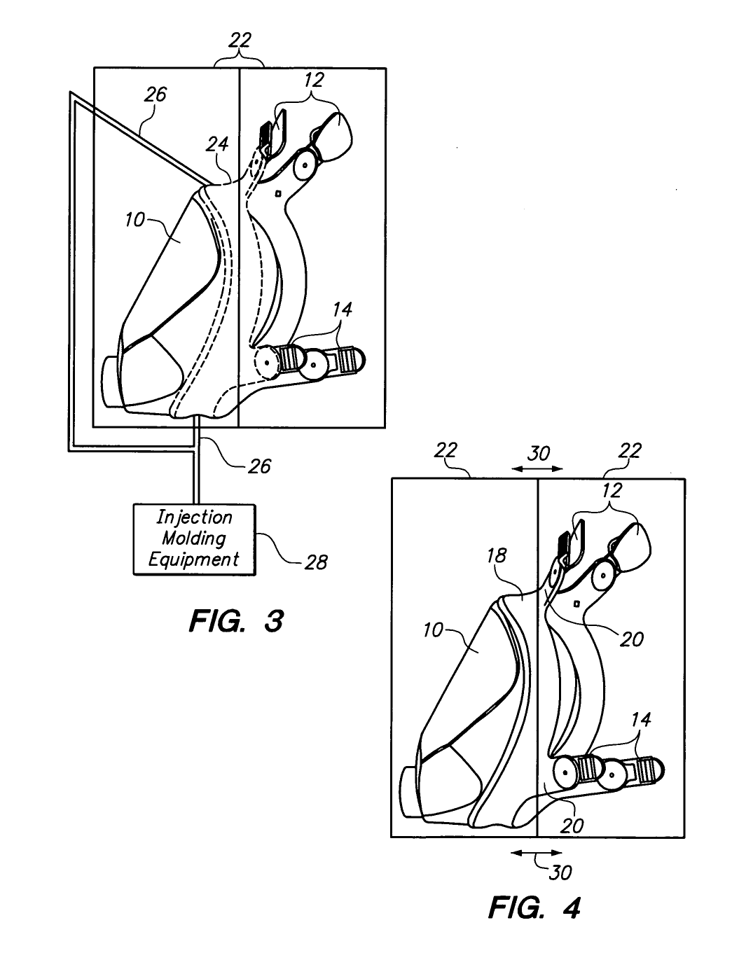

FIG. 3 illustrates the same components parts shown in FIG. 2 but positioned within a two-piece mold member 22. As can be seen the two-piece mold member has a mold cavity 24 in dotted line which is the same shape as the flange member 18 shown in FIG. 2. Injection ports 26 extend through the two-piece mold 22 and with an injection molding equipment 28 attached to the ports for injection molding thermoplastic material into the mold cavity 24.

FIG. 4 illustrates the assembled respirator located within the two-piece 22 and as shown by arrows 30 the mold may be split along the direction of the arrows 30 so that the assembled respirator can be released from the mold. It will be appreciated that other component members can then be attached to the assembled respirator including harness members attached to the buckle portions and other accessories attached to the lens for completion of a full face respirator.

It will be appreciated that other variations and modifications may be made to the invention as described without deviating from the spirit of the invention as described above.

I claim:

1. A method of manufacturing a respirator mask including the following steps,
providing a lens member,
providing a plurality of buckle members,
providing a mold member having individual mold supports to individually receive and support the lens member and to individually receive and support the buckle members at spaced positions around the lens member and to form a flange cavity around the lens member and extending to the buckle members,
positioning the lens member within its individual mold support,
positioning the buckle members within their individual mold supports at spaced positions around the lens member, and
injecting molding material into the flange cavity to form a flange that overmolds to the lens member while at the same time overmolds to the buckle members to form a respirator mask.

2. The method of claim 1 wherein the mold member is at least a two-piece mold that can be split apart to release the respirator mask after molding the flange.

3. The method of claim 1 wherein each buckle members is provided with an opening extending through the buckle member so that the molding material can flow through the opening to further secure each buckle member to the flange member.

4. The method of claim 1 wherein the molding material is a thermoplastic rubber.

5. (canceled)

6. (canceled)

7. (canceled)

8. (canceled)
